(19) United States
(12) Patent Application Publication
(10) Pub. No.: US 2015/0016452 A1
(43) Pub. Date: Jan. 15, 2015

(54) COMMUNICATION NODE DEVICE, COMMUNICATION SYSTEM, COMMUNICATION CONTROL METHOD AND COMPUTER-READABLE PROGRAM PRODUCT

(71) Applicant: Kabushiki Kaisha Toshiba, Minato-ku (JP)

(72) Inventors: Yoshihiro OBA, Kawasaki-shi (JP); Yusuke Doi, Yokohama-shi (JP); Seijiro Yoneyama, Yokohama-shi (JP); Yasuyuki Tanaka, Fuchu-shi (JP)

(73) Assignee: Kabushiki Kaisha Toshiba, Minato-ku (JP)

(21) Appl. No.: 14/327,726

(22) Filed: Jul. 10, 2014

(30) Foreign Application Priority Data
Jul. 10, 2013 (JP) 2013-144864

(51) Int. Cl. H04L 12/18

(52) U.S. Cl. CPC H04L 12/18
USPC 370/390

(57) ABSTRACT

A communication node device according to embodiments is capable of transmitting and receiving a multicast message with an adjacent node connected to the same multicast link. The device may comprise a first transmitting and receiving unit, a storage unit, a detection unit, and a second transmitting and receiving unit. The first transmitting and receiving unit may be configured to transmit and receive a multicast message with the adjacent node. The storage unit may be configured to store a message transmitted or received by the first transmitting and receiving unit. The detection unit may be configured to detect interruption of reception continuity of multicast message with the adjacent node. The second transmitting and receiving unit may be configured to, when the detection unit detects interruption of reception continuity of multicast message with the adjacent node, transmit a request for sending multicast message to the adjacent node.

### CROSS-REFERENCE TO RELATED APPLICATION(S)

This application is based upon and claims the benefit of priority from the Japanese Patent Application No. 2013-144864, filed on Jul. 10, 2013; the entire contents of which are incorporated herein by reference.

### FIELD

Embodiments described herein relate generally to a communication node device, a communication system, a communication control method and a computer-readable program product.

### BACKGROUND

IETF RFC6550., RPL: IPv6 Routing Protocol for Low-Power and Lossy Networks (Proposed standard, 2012) as Reference 1 stipulates a routing protocol RPL for network (IPv6 Routing Protocol for Low-Power and Lossy Network). In an operation mode of Storing Mode in RPL, it is possible to construct a multicast routing topology.

IETF I.D., draft-ietf-trickle-mcast-03, “Multicast Protocol for Low power and Lossy Networks (MPL)”, Jan. 24, 2013 as Reference 2 stipulates a trickle multicast being a flooding multicast protocol for meshed network. To each message of the trickle multicast, an identifier (seed ID) of the trickle multicast source and a sequence number are assigned. Each node can store a transferred message during a first period of time (Tdwell) and discard a redundantly-received message. Furthermore, each node can store a transferred message during a second period of time (Tactive), and resend the message on a periodic basis (the interval between resending processes will increase exponentially) (resend mode). Moreover, instead of the periodic resending, each node can intercommunicate information about received messages with the other nodes on a periodic basis (note, an interval thereof will increase exponentially), and send a message which is not received by the other nodes selectively based on the information (suppression mode).

In Reference 1, when the multicast routing topology, alertness level of node, or the like, is changed during multicast transfer, lost message may occur.

In Reference 2, although it is possible to decrease lost message, when a size of network is large, the resend mode may increase network load and the suppression mode may increase multicast transfer delay.

### BRIEF DESCRIPTION OF THE DRAWINGS

FIG. 1 is a block diagram showing an example of an outline configuration of a communication node device according to a first embodiment;

FIG. 2 is a flowchart showing an operation example of receiving a multicast message according to the first embodiment;

FIG. 3 is a flowchart showing an operation example of receiving asynchronous event according to the first embodiment;

FIG. 4 is a block diagram showing an example of an outline configuration of a communication node device according to a second embodiment;

FIG. 5 is a flowchart showing an operation example of receiving a multicast message according to the second embodiment;

FIG. 6 is a flowchart showing an operation example of receiving asynchronous event according to the second embodiment;

FIG. 7 is a flowchart showing an example of receiving operation of a multicast control message according to the second embodiment;

FIG. 8 is a first conceptual diagram showing a transfer example of a multicast message on a multihop wireless network according to a third embodiment;

FIG. 9 is a second conceptual diagram showing a transfer example of a multicast message on a multihop wireless network according to the third embodiment;

FIG. 10 is a third conceptual diagram showing a transfer example of a multicast message on a multihop wireless network according to the third embodiment;

FIG. 11 is a fourth conceptual diagram showing a transfer example of a multicast message on a multihop wireless network according to the third embodiment;

FIG. 12 is a fifth conceptual diagram showing a transfer example of a multicast message on a multihop wireless network according to the third embodiment;

FIG. 13 is an illustration showing an example of multicast message information stored in a storage unit according to one of the first to third embodiments;

FIG. 14 is an example of adjacent node information managed by a continuity detection unit in a communication node device N5 in FIG. 11;

FIG. 15 is an illustration showing an example of format of a multicast message according to one of the first to third embodiments;

FIG. 16 is an illustration showing an example of format of a request for sending multicast message according to one of the first to third embodiments; and

FIG. 17 is an illustration showing an example of format of multicast transfer control command according to one of the first to third embodiments.

### DETAILED DESCRIPTION

Exemplary embodiments of a communication node device, a communication system, a communication control method, and a computer-readable program product will be explained below in detail with reference to the accompanying drawings.

In the following embodiments, for example, a transmitted or received multicast message is stored during a certain period, a request for sending multicast message is transmitted to an adjacent node when reception continuity of a multicast message with the adjacent node is interrupted, and the stored multicast message is transmitted when the request for sending multicast message is received from the adjacent node. Thereby, it is possible to prevent a multicast message from being lost due to a change of a multicast routing topology, an alertness level of node, or the like, while suppressing network load and multicast transfer delay.

### First Embodiment

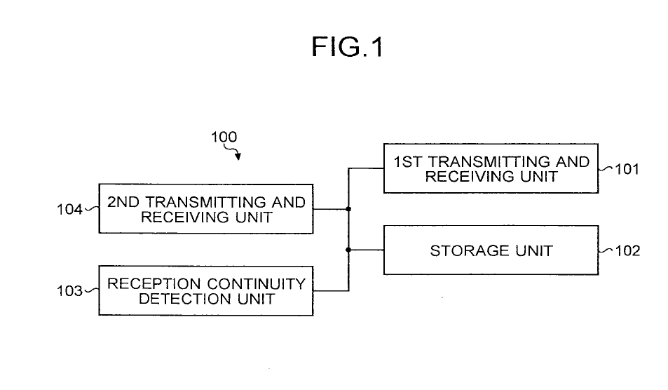

In the following, a first embodiment will be described in detail with reference to the accompanying drawings. FIG. 1 is a block diagram showing an example of an outline configuration of a communication node device according to the first embodiment. As shown in FIG. 1, a communication node device 100 has a first transmitting and receiving unit 101, a storage unit 102, a reception continuity detection unit 103 and a second transmitting and receiving unit 104. Each unit shown in FIG. 1 can be provided as a dedicated chip in which respective functions are previously programmed, or as a function executed on a processor such as a CPU (central processing unit), or the like, the processor executing a program stored in a storage unit such as a ROM (read only memory), a RAM (random access memory), or the like.

The first transmitting and receiving unit 101 transmits and receives a multicast message with other communication node devices. The storage unit 102 stores a multicast message transmitted or received by the first transmitting and receiving unit 101 for a certain period. The reception continuity detection unit 103 detects interruption of reception continuity of multicast message. Here, reception continuity is defined by radio wave strength between linked communication node devices (hereinafter to be referred to as adjacent nodes), operation state of the communication node device, and so forth.

The second transmitting and receiving unit 104 transmits a request for sending multicast message to the adjacent node when the reception continuity detection unit 103 detects interruption of reception continuity of multicast message from a certain adjacent node. Furthermore, when the second transmitting and receiving unit 104 receives a request for sending multicast message from the adjacent node, the second transmitting and receiving unit 104 instructs the first transmitting and receiving unit 101 to send a multicast message stored in the storage unit 102.

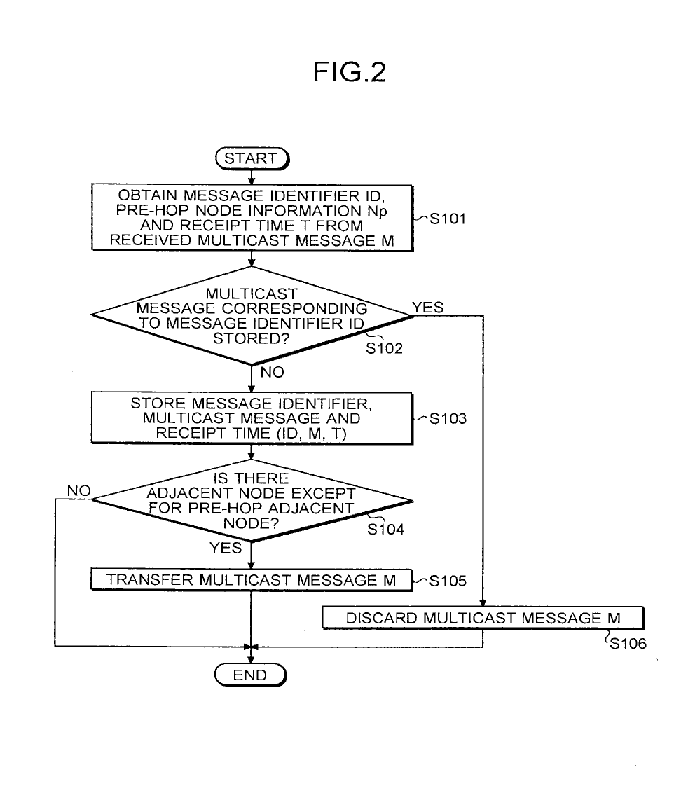

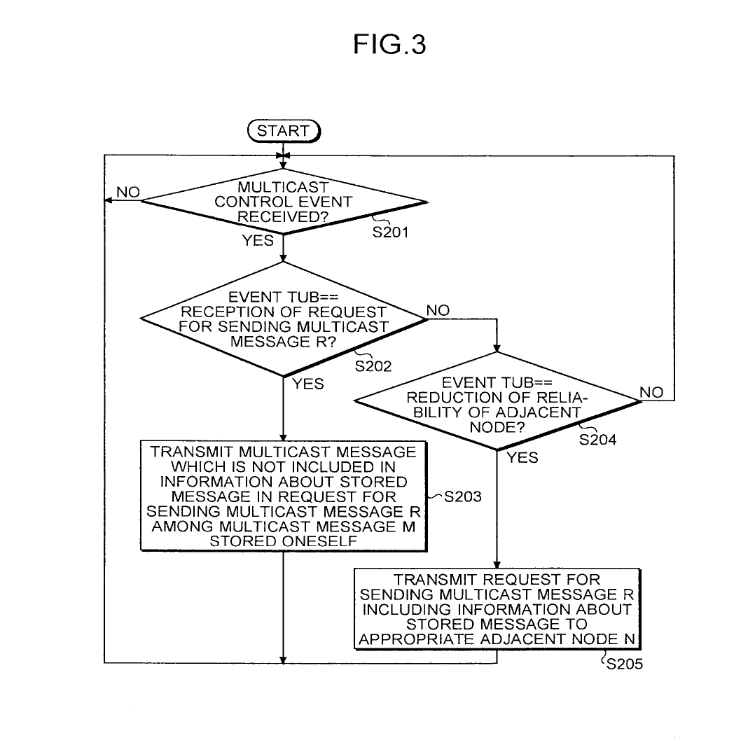

Next, an operation of the communication node device 100 according to the first embodiment will be described in detail with the accompanying drawings. FIG. 2 is a flowchart showing an operation example of receiving a multicast message according to the first embodiment. FIG. 3 is a flowchart showing an operation example of receiving asynchronous event according to the first embodiment. In FIG. 2, an operation of the first transmitting and receiving unit 101 will be explained. In FIG. 3, an operation of the second transmitting and receiving unit 104 will be explained.

As shown in FIG. 2, when the first transmitting and receiving unit 101 receives a multicast message M, the first transmitting and receiving unit 101 obtains a message identifier ID, pre-hop node information Np and a receipt time T from the received multicast message M (step S101). The message identifier ID is an identifier for identifying the multicast message M. The pre-hop node information Np is information indicating a communication node device which hops (transfers) the multicast message M just before the communication node device 100 receives the multicast message M. The receipt time T may be a current time managed by the communication node device 100. Then, the first transmitting and receiving unit 101 determines whether the storage unit 102 stores the multicast message M corresponding to the message identifier ID (step S102).

As a result of the determination in step S102, when the multicast message M corresponding to the message identifier IL) is stored in the storage unit 102 (step S102; YES), the first transmitting and receiving unit 101 instructs the storage unit 102 to delete the received multicast message M (step S106). On the other hand, when the multicast message M corresponding to the message identifier ID is not stored in the storage unit 102 (step S102; NO), the first transmitting and receiving unit 101 instructs the storage unit 102 to store the message identifier ID, the multicast message M and the current time T (step S103).

Next, the first transmitting and receiving unit 101 determines whether another adjacent node except for the adjacent node corresponding to the pre-hop node information Np (in the following, for the sake of shorthand, referred to as a pre-hop adjacent node Np) exists or not (step S104). When there is no another adjacent node except for the pre-hop adjacent node Np (step S104; NO), the first transmitting and receiving unit 101 finishes this receiving operation. On the other hand, when another adjacent node except for the pre-hop adjacent node Np exists (step S104; YES), the first transmitting and receiving unit 101 transfers the received multicast message M to said another adjacent node (step S105), and finishes this receiving operation.

As shown in FIG. 3, the second transmitting and receiving unit 104 waits until the second transmitting and receiving unit 104 receives a multicast control event from another communication node device (step S201; NO). The multicast control event is an event for control a multicast communication, or the like, executed at each adjacent node with one another. When the second transmitting and receiving unit 104 receives the multicast control event (step S201; YES), the second transmitting and receiving unit 104 determines whether the multicast control event is reception of a request for sending multicast message R based on an event type of the received multicast control event (step S202).

When the multicast control event is reception of a request for sending multicast message R (step S202; YES), the second transmitting and receiving unit 104 instructs the first transmitting and receiving unit 101 to transmit a multicast message not included in information about stored message of the request for sending multicast message R among multicast messages stored in the storage unit 102 (step S203), and returns to step S201. At this time, the multicast message can be transmitted using native multicast or be transmitted to a source node N being a source of the request for sending multicast message R by using unicast. Here, the information about stored message may be a list of message identifiers ID of all multicast messages stored in the own storage unit 102.

On the other hand, when the event type is not reception of the request for sending multicast message R (step S202; NO), and when the event type indicates degradation of reliability of adjacent node (step S204; YES), the second transmitting and receiving unit 104 transmits a request for sending multicast message R including information about stored message stored in the storage unit 102 to an adjacent node N of which degradation of reliability of adjacent node is detected by the reception continuity detection unit 103 (step S205), and returns to step S201. On the other hand, when the event type does not indicate degradation of reliability of adjacent node (step S204; NO), the second transmitting and receiving unit 104 returns to step S201. The degradation of reliability of adjacent node is a state where reception continuity with an adjacent node is decreased. The degradation of reliability of an adjacent node may be a case where metric about reliability of a link layer for an adjacent node falls below a specific threshold.

As described above, according to the communication node device 100 according to the first embodiment, the transmitted or received multicast message M is stored during a certain period, and the request for sending multicast message R is transmitted to an adjacent node when reception continuity of a multicast message with the adjacent node is interrupted. Furthermore, when the request for sending multicast message R is received from the adjacent node, the stored multicast message M is transmitted. Thereby, it is possible to prevent a multicast message from being lost due to a change of a multicast routing topology, an alertness level of node, or the like, while suppressing network load and multicast transfer delay.

### Second Embodiment

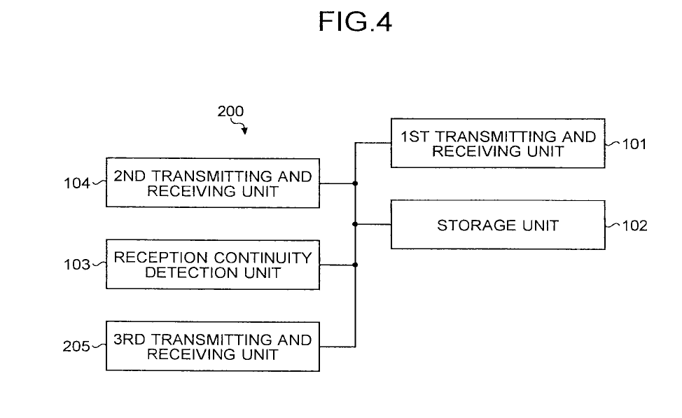

Next, a second embodiment will be described in detail with accompanying drawings. FIG. 4 is a block diagram showing an example of an outline configuration of a communication node device according to the second embodiment. As shown in FIG. 2, a communication node device 200 has a third transmitting and receiving unit 205 in addition to the units 101 to 104 of the communication node device 100 according to the first embodiment.

The third transmitting and receiving unit 205 transmits and receives a multicast transfer control command. When the third transmitting and receiving unit 205 receives a multicast transfer control command indicating interruption of transmission and reception of a multicast message, the third transmitting and receiving unit 205 instructs the second transmitting and receiving unit 104 and the first transmitting and receiving unit 101 to interrupt transmission and reception of a multicast message. When the third transmitting and receiving unit 205 receives a multicast transfer control command indicating restart of transmission and reception of a multicast message, the third transmitting and receiving unit 205 instructs the second transmitting and receiving unit 104 and the first transmitting and receiving unit 101 to restart transmission and reception of a multicast message. Furthermore, when the third transmitting and receiving unit 205 receives a multicast transfer control command indicating reset of stored multicast messages, the third transmitting and receiving unit 205 instructs the storage unit 102 to delete the multicast messages stored in the storage unit.

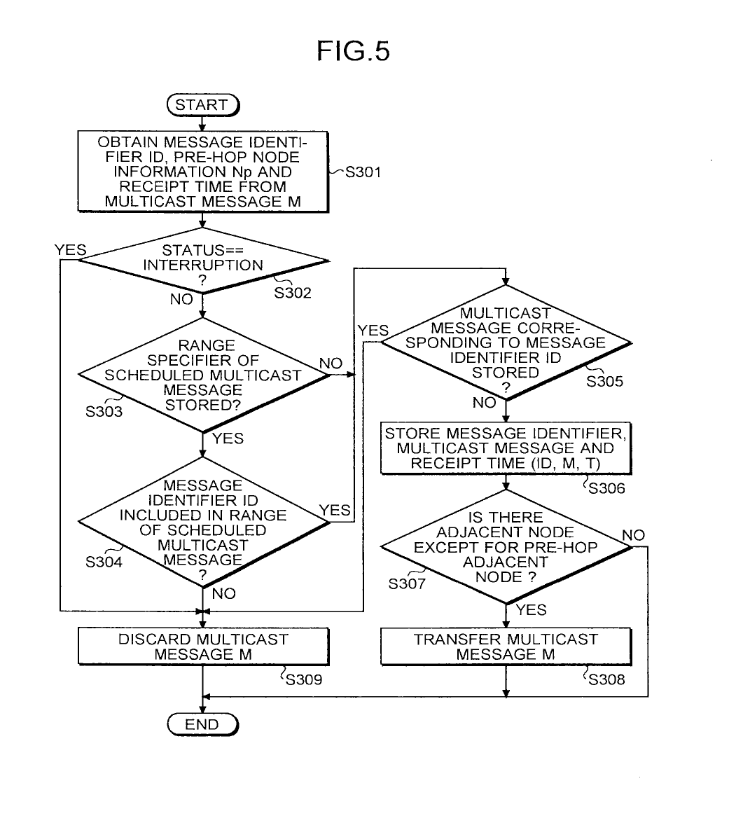

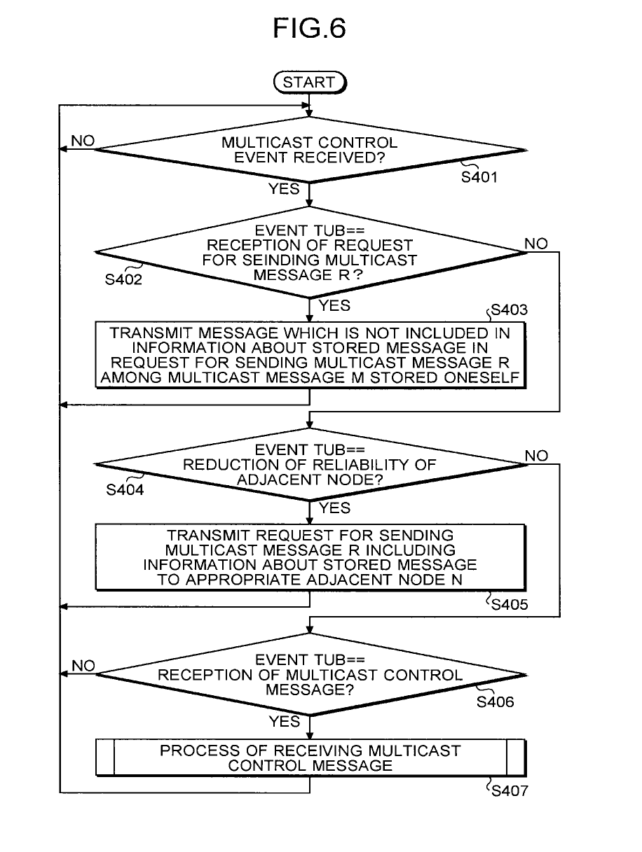

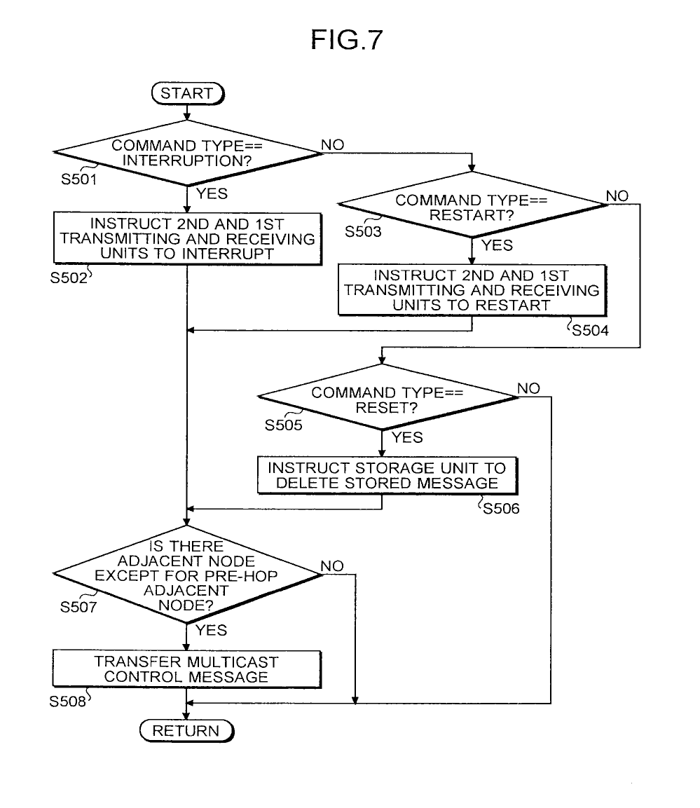

Next, an operation of the communication node device 200 according to the second embodiment will be described in detail with the accompanying drawings. FIG. 5 is a flowchart showing an operation example of receiving a multicast message according to the second embodiment. FIG. 6 is a flowchart showing an operation example of receiving asynchronous event according to the second embodiment. FIG. 7 is a flowchart showing an example of receiving operation of a multicast control message according to the second embodiment. In FIG. 5, an operation of the first transmitting and receiving unit 101 will be explained. In FIG. 6, an operation of the second transmitting and receiving unit 104 will be explained. In FIG. 7, an operation of the third transmitting and receiving unit 205 will be explained.

As shown in FIG. 5, when the first transmitting and receiving unit 101 receives a multicast message M, the first transmitting and receiving unit 101 obtains a message identifier ID, pre-hop node information Np and a receipt time T from the received multicast message M (step S301). Then, the first transmitting and receiving unit 101 determines whether an own status indicates interruption of transmission and reception of a multicast message or not (step S302). When the status indicates interruption (step S302; YES), the first transmitting and receiving unit 101 discards the received multicast message M (step S309), and finishes this operation.

On the other hand, when the status does not indicate interruption (step S302; NO), the first transmitting and receiving unit 101 determines whether a range specifier of a message identifier of a multicast message being to be transmitted (hereinafter to be referred to as a range specifier of a scheduled multicast message) is stored or not (step S303). When the range specifier of the scheduled multicast message is stored (step S303; YES), the first transmitting and receiving unit 101 progresses to step S304, and when the range specifier of the scheduled multicast message is not stored (step S303; NO), the first transmitting and receiving unit 101 progresses to step S305.

In step S304, the first transmitting and receiving unit 101 determines whether the message identifier ID of the received multicast message M is included in a scheduled multicast message range assigned by the range specifier of the scheduled multicast message or not. When the message identifier ID is included in the scheduled multicast message range (step S304; YES), the first transmitting and receiving unit 101 progresses to step S305, and when the message identifier ID is not included in the scheduled multicast message range (step S304; NO), the first transmitting and receiving unit 101 discards the multicast message M (step S309), and finishes this operation.

In step S305, the first transmitting and receiving unit 101 determines whether the multicast message M corresponding to the message identifier ID is stored in the storage unit 102 or not (step S305). When the multicast message M corresponding to the message identifier ID is stored in the storage unit 102 (step S305; YES), the first transmitting and receiving unit 101 discards the received multicast message M (step S309), and finishes this operation.

On the other hand, when the multicast message M corresponding to the message identifier ID is not stored in the storage unit 102 (step S305; NO), the first transmitting and receiving unit 101 instructs the storage unit 102 to store the message identifier ID, the multicast message M and the current time T (step S306).

Then, the first transmitting and receiving unit 101 determines whether another adjacent node except for the pre-hop adjacent node Np exists or not (step S307). When another adjacent node except for the pre-hop adjacent node does not exist (step S307; NO), the first transmitting and receiving unit 101 finishes this operation. On the other hand, when another adjacent node except for the pre-hop adjacent node exists (step S307; YES), the first transmitting and receiving unit 101 transfers the received multicast message M to the another adjacent node (step S308), and finishes this operation.

As shown in FIG. 6, the second transmitting and receiving unit 104 waits until the second transmitting and receiving unit 104 receives a multicast control event from another communication node device (step S401; NO). When the second transmitting and receiving unit 104 receives the multicast control event (step S401; YES), the second transmitting and receiving unit 104 determines whether an event type of the received multicast control event is reception of a request for sending multicast message R (step S402).

When the multicast control event is reception of a request for sending multicast message R (step S402; YES), the second transmitting and receiving unit 104 instructs the first transmitting and receiving unit 101 to transmit a multicast message not included in information about stored message of the request for sending multicast message R among multicast messages stored in the storage unit 102 (step S403), and returns to step S401. At this time, the multicast message can be transmitted using native multicast or be transmitted to a source node N being a source of the request for sending multicast message R by using unicast.

On the other hand, when the event type is not reception of the request for sending multicast message R (step S402; NO), and when the event type indicates degradation of reliability of adjacent node (step S404; YES), the second transmitting and receiving unit 104 transmits a request for sending multicast message R including information about stored message stored in the storage unit 102 to an adjacent node N of which degradation of reliability of adjacent node is detected by the reception continuity detection unit 103 (step S405), and returns to step S401.

On the other hand, when the event type does not indicate degradation of reliability of adjacent node (step S404; NO), the second transmitting and receiving unit 104 determines whether the event type is reception of a multicast control message or not (step S406). When the event type is reception of a multicast control message (step S406; YES), the second transmitting and receiving unit 104 executes a process of receiving a multicast control message (step S407), and returns to step S401. On the other hand, when the event type is not reception of a multicast control message (step S406; NO), the second transmitting and receiving unit 104 directly returns to step S401.

As shown in FIG. 7, in the process of receiving a multicast control message of step S407 in FIG. 6, the third transmitting and receiving unit 205 determines whether a type of a multicast transfer control command included in the received multicast control message indicates interruption of transmission and reception of a multicast message or not (step S501). When the type of the multicast transfer control command indicates interruption (step S501; YES), the third transmitting and receiving unit 205 instructs the second transmitting and receiving unit 104 and the first transmitting and receiving unit 101 to interrupt transmission and reception of a multicast message (step S502), and progresses to step S507.

On the other hand, when the type of the multicast transfer control command does not indicate interruption (step S501; NO), the third transmitting and receiving unit 205 determines whether the type of the multicast transfer control command indicates restart of transmission and reception of a multicast message or not (step S503). When the type of the multicast transfer control command indicates restart (step S503; YES), the third transmitting and receiving unit 205 instructs the second transmitting and receiving unit 104 and the first transmitting and receiving unit 101 to restart transmission and reception of a multicast message (step S504), and progresses to step S507.

On the other hand, when the type of the multicast transfer control command does not indicate restart (step S503; NO), the third transmitting and receiving unit 205 determines whether the type of the multicast transfer control command indicates reset of stored multicast messages or not (step S505). When the type of the multicast transfer control command indicates reset (step S505; YES), the third transmitting and receiving unit 205 instructs the storage unit 102 to delete stored messages (step S506), and progresses to step S507. On the other hand, the type of the multicast transfer control command does not indicate reset (step S505; NO), the third transmitting and receiving unit 205 finishes this operation and returns to the operation shown in FIG. 6.

In step S507, the third transmitting and receiving unit 205 determines whether another adjacent node except for the pre-hop adjacent node Np exists or not. When another adjacent node exists (step S507; YES), the third transmitting and receiving unit 205 transfers the received multicast control message (step S508), and finishes this operation and returns to the operation shown in FIG. 6. On the other hand, when another adjacent node except for the pre-hop adjacent node Np does not exist (step S507; NO), the third transmitting and receiving unit 205 directly finishes this operation and returns to the operation shown in FIG. 6.

As described above, according to the communication node device 200 according to the second embodiment, the multicast transfer control command is transmitted and received. Thereby, in addition to the effects according to the communication node device 100 according to the first embodiment, when network load is high, it is possible to interrupt multicast transfer and prioritize unicast communication. Furthermore, when delivery of new multicast contents is started, it is possible to free a memory region for old multicast contents stored in each communication node and assign the memory region to the delivery of new multicast contents.

### Third Embodiment

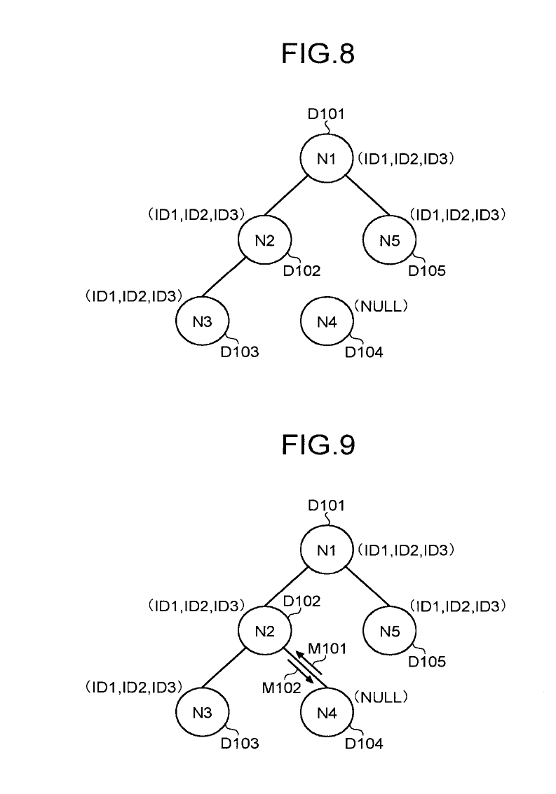

Next, as a third embodiment, using FIGS. 8 to 17, an example of transfer of a multicast message in a wireless multihop network constructed using the communication node device according to the first or second embodiment will be described in detail.

In FIGS. 8 to 12, the wireless multihop network is constructed from five communication nodes N1 (D101), N2 (D102), N3 (D103), N4 (D104) and N5 (D105). The communication node device N1 (D101) is defined as a source of all multicast messages.

In FIG. 8, the communication node device N1 (D101) and the communication node device N2 (D102), the communication node device N2 (D102) and the communication node device N3 (D103), and the communication node device N1 (D101) and the communication node device N5 (D105) are pairs of adjacent nodes, respectively. In each pair of the adjacent nodes, messages can be exchanged between each other.

In FIG. 8, it is assumed that the communication node device N4 (D104) has not yet established a relationship of adjacent nodes with any communication device. Furthermore, each communication node device N1 (D101), N2 (D102), N3 (D103) and N5 (D105) stores multicast messages MM1, MM2 and MM3 which are identified by message identifiers ID1, ID2 and ID3, respectively, and the communication node device N4 (D104) does not store any multicast message.

Now, from the state shown in FIG. 8, it is assumed that the communication node device N4 (D104) has become an adjacent node of the communication device N3 (D103). FIG. 9 shows a state after such change. In FIG. 9, the communication node device N4 (D704) transmits a request for sending multicast message MMreq (M101) to the communication node device N3 (D103). Because the communication node device N4 (D104) does not any store multicast message, information about stored message in the request for sending multicast message MMreq (M101) transmitted from the communication node device N4 (D104) to the communication node device N3 (D103) is set as null. When the communication node device N3 (D103) receives the request for sending multicast message MMreq (M101), the communication node device N3 (D103) transmits the multicast messages MM1, MM2 and MM3 (which correspond to the message identifiers ID1, ID2 and ID3, respectively) stored oneself to the communication node N4 (D104).

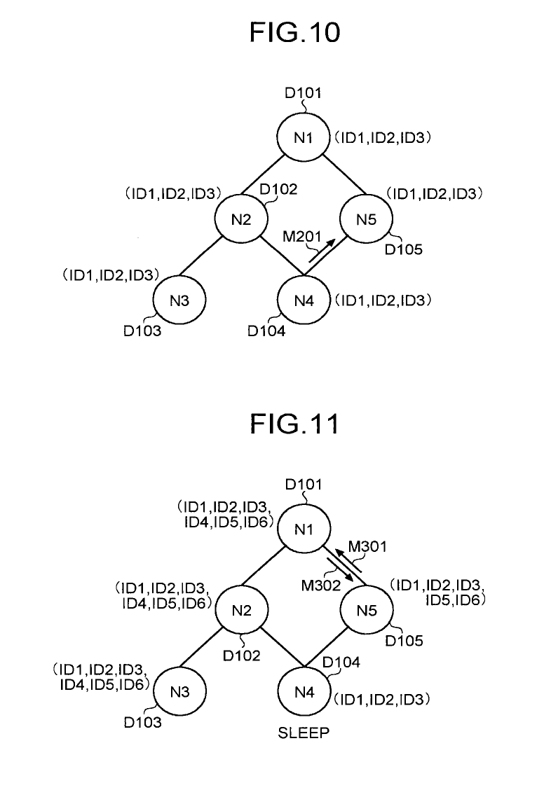

Then, it is assumed that the state in which the communication node device N4 (D104) receives the three multicast messages M102 as shown in FIG. 9 changes to a state in which the communication node device N4 (D104) becomes an adjacent node of the communication node device N5 (D105). The state after such change is shown in FIG. 10. In FIG. 10, the communication node device N4 (D104) transmits a request for sending multicast message MMreq (M201) to the communication node device N5 (D105). Information about stored message in the request for sending multicast message MMreq (M201) which is transmitted from the communication node device N4 (D104) to the communication node device N5 (D105) is the message identifiers ID1, ID2 and ID3. When the communication node device N5 (D105) receives the request for sending multicast message MMreq (M201), because all the multicast messages MM1, MM2 and MM3 stored in itself is included in the information about stored message of the request for sending multicast message MMreq (M201), the communication node device N5 (D105) transmits the multicast messages to the communication node device N4 (D104).

Next, it is assumed that the state after the communication node device N5 (D105) received the request for sending multicast message MMreq (M201) as shown in FIG. 10 changes to a state in which the communication node device N4 (D104) becomes a sleep state, and the communication node device N1 (D101) transmits new three multicast messages MM4, MM5 and MM6 (which correspond to message identifiers ID4, ID5 and 1D6, respectively) to the communication node devices D2 (D102) and D5 (D105). Furthermore, it is assumed that the communication node device N2 (D102) receives the three multicast messages MM4, MM5 and MM6 and transfers the multicast messages to the communication node device N3 (D103), while the communication node device N5 (D105) receives only two multicast messages MM5 and MM6 due to reduction of link reliability between the communication node device N1 (D101) and the communication node device N5 (D105). FIG. 11 shows a state after such change. In FIG. 11, the communication node device N5 (D105) transmits a request for sending multicast message MMreq (M301) to the communication node device N1 (D101). Information about stored message in the request for sending multicast message MMreq (M301) to be transmitted from the communication node device N5 (D105) to the communication node device N1 (D101) is message identifiers ID1, ID2, ID3, ID5 and ID6. When the communication node device N1 (D101) receives the request for sending multicast message MMreq (M301), because the message identifier ID4 among the multicast messages stored oneself is not included in the information about stored message of the request for sending multicast message MMreq (D301), the communication node device N1 (D101) transfers a multicast message MM4 (M302) corresponding to the message identifier ID4 to the communication node device N5 (D105).

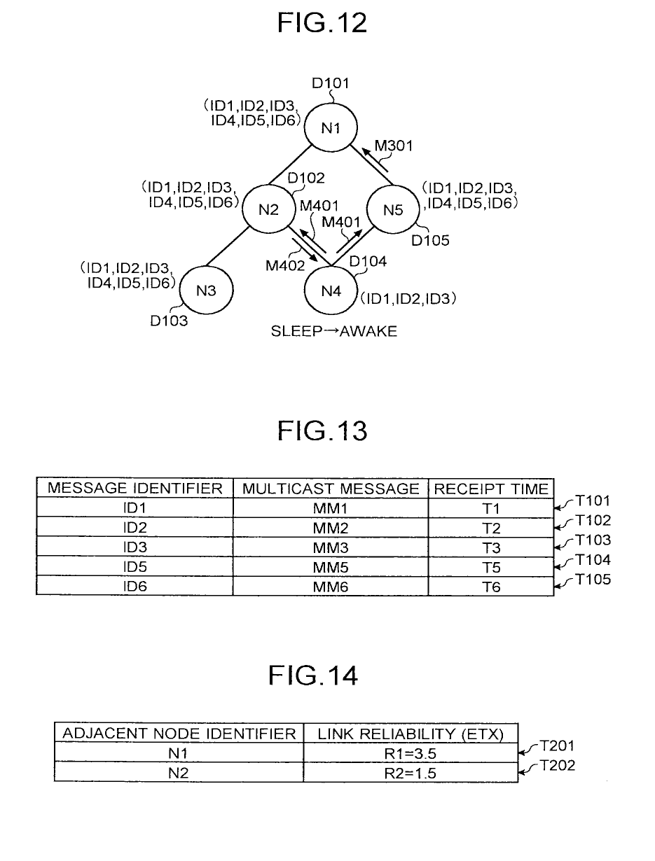

Next, it is assumed that the state after the communication node device N5 (D105) receives the multicast message MM4 (M302) as shown in FIG. 11 changes to a state in which the communication node device N4 (D104) becomes an awake state from the sleep state. FIG. 12 shows a state after such change. In FIG. 12, the communication node device N4 (D104) transmits a request for sending multicast message MMreq (M401) to the communication node devices N3 (D103) and N5 (D105). Information about stored message in the request for sending multicast message MMreq (M401) to be transmitted from the communication node device N4 (D104) to the communication node devices N3 (D103) and N5 (D105) is message identifiers ID1, ID2 and ID3. When the communication node device N3 (D103) receives the request for sending multicast message MMreq (M401), because the message identifiers ID1, ID2 and ID3 among multicast messages stored oneself are not included in the information about stored message of the request for sending multicast message MMreq (M401), the communication node device N3 (D103) transfers the multicast messages MM4, MM5 and MM6 (M402) corresponding to the message identifiers ID4, ID5 and 1D6 to the communication node device N5 (D105). When the communication node device N5 (D105) receives the request for sending multicast message MMreq (M401), because all the multicast message stored in itself is included in the information about stored message of the request for sending multicast MMreq (M401), the communication node device N5 (D105) does not transmit any multicast message to the communication node device N4 (D104).

In FIG. 13, an example of information about stored message stored in the storage unit 102 in the communication node device N5 (D105) in FIG. 11 is shown. In FIG. 13, the information about stored message is represented as a table in which three items being a message identifier, a multicast message and a receipt time are defined as a single record. In FIG. 13, five entries T101 to T105 are registered. The receipt time is used for deleting a table entry including a multicast message which is stored for a certain period of time or longer, for instance.

Next, in FIG. 14, an example of information of adjacent node managed by the reception continuity detection unit 103 in the communication node device N5 (D105) in FIG. 11 is shown. In FIG. 14, the information about adjacent node is represented as a table in which two items being an adjacent node identifier and link reliability (ETX) are defined as a single record. In FIG. 14, two entries T201 and T202 is registered. The adjacent node identifier is a preset identifier for an adjacent node establishing a link with own node. This can be a MAC address of a communication node device, for instance. The link reliability (ETX) may be metric about reliability of link layer for an adjacent node calculated by the reception continuity detection unit 103 based on radio wave strength, an operation state of an adjacent node, and so forth, for instance. The metric about reliability of link layer is not limited to the Expected Transmission count Metric (ETX) while it is also possible to be the Link Quality Level (LQL).

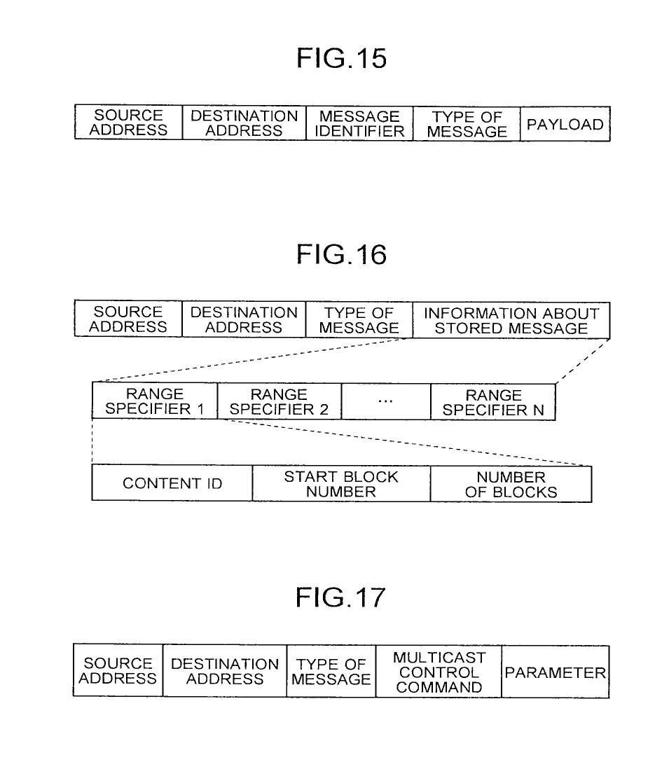

Then, an example of format of a multicast message is shown in FIG. 15. In FIG. 15, a multicast message includes a source address, a destination address, a message identifier, a type of message and a payload. The source address is an address of a communication device which has primarily transmitted the multicast message. The destination address is an address of a communication device which is to receive the multicast message. The destination address may include a multicast group address. When application layer multicast is used, as the source address and the destination address can include a source identifier and a group identifier of an application layer, respectively. The type of message is information indicating whether the message is a multicast control event such as a request for sending multicast message, or the like, in addition to whether the message is a multicast message or a unicast message.

Next, in FIG. 16, an example of format of a request for sending multicast message is shown. In FIG. 16, a request for sending a multicast message includes a source address, a destination address, a type of message and information about stored message. The source address is an address of a communication node device which has transmitted the request for sending multicast message. The destination address is an address of a communication node device being a destination of the request for sending multicast message. The information about stored message is constructed from a list of range specifiers. Each range specifier includes a content ID, a start block number and the number of blocks.

Next, in FIG. 17, an example of format of a multicast control message is shown. In FIG. 17, a multicast control message includes a source address, a destination address, a type of message, a multicast transfer control command and a parameter. The source address is an address of a communication node device which has transmitted the multicast control message. The destination address is an address of a communication node address being destination of the multicast control message. The parameter is information necessary for executing an operation instructed by the multicast transfer control command. For example, when the multicast transfer control command indicates reset, the parameter may include a range specifier of a scheduled multicast message. Furthermore, when the multicast transfer control command indicates interruption, the parameter may include a restart time.

Each of the communication node devices exampled in the above-described embodiments can use a general-purpose computer as a basic hardware. That is, the first transmitting and receiving unit 101, the storage unit 102, the reception continuity detection unit 103, the second transmitting and receiving unit 104 and the third transmitting and receiving unit 205 can be realized by letting one or more processors installed in the general-purpose computers execute programs. In such configuration, it is possible to realize the communication node device by preinstalling the programs in a computer device, or by distributing the programs to the computer device via a medium such as a CD-ROM, a network, or the like, and installing the programs in the computer device. The storage unit 102 can be realized using a non-transitory computer-readable medium such as an embedded or external memory of the computer device, a hard disk, a CD-R, a CD-RW, a DVD-RAM, a DVD-R, or the like.

As described above, the communication node device according to one of the above-described embodiments comprises: a first transmitting and receiving unit 101 configured to transmit and receive a multicast message; a storage unit 102 configured to store a message transmitted or received by the first transmitting and receiving unit 101 during a certain period; a reception continuity detection unit 103 configured to detect interruption of reception continuity of multicast message; and a second transmitting and receiving unit 104 configured to, when the reception continuity detection unit 103 detects interruption of reception continuity of multicast message with the adjacent node, transmit a request for sending multicast message to the adjacent node, and when a request for sending multicast message form the adjacent node, instruct the first transmitting and receiving unit 101 to transmit a multicast message stored in the storage unit 102.

When an adjacent node newly adds to the multicast link, the reception continuity detection unit 103 may determines that maintaining reception continuity of the multicast messages with this adjacent node has become impossible. Furthermore, the second transmitting and receiving unit 104 may use a request for joining multicast group as a request for sending multicast message. In such case, as the request for joining multicast group, a message for joining multicast group in the multicast routing protocol, the multicast listener management protocol, or the like, may be used. As the message for joining multicast group in the multicast routing protocol, there is a Join/Prune message in RFC 3973 (PIM-SM), for instance. As the message for joining multicast group in the multicast listener management protocol, there is a Membership Report message described in “RFC 3376(IGMPv3)” and a Multicast Listener Report message described in “RFC 3810(=v2)”, for instance. Furthermore, as the request for sending multicast message, routing information advertising in the routing protocol may be used. In such case, as the routing information advertising in the routing protocol, a DAO (destination advertisement object) in the RPL may be used.

When own node changes from a sleep state to an awake state, the reception continuity detection unit 103 may determine that maintaining reception continuity of the multicast messages with all of the adjacent nodes has become impossible. In such case, as for the request for sending multicast message to be transmitted from the second transmitting and receiving unit 104 may include information about own dormant period.

When metric about reliability of link layer for a certain adjacent node becomes below a certain threshold, the reception continuity detection unit 103 may determine that maintaining reception continuity of the multicast messages from this adjacent node has become impossible. In such case, as the metric about reliability of link layer, a Link Quality Level (LQL) or an Expected Transmission count Metric (ETX) may be used. In addition, with respect to a disconnected link, a multicast routing control for detouring such link is executed based on the routing protocol.

The request for sending multicast message can include information about stored message. The second transmitting and receiving unit 104 can selectively transmit a message which is not included in the information about stored message to a source of the request for sending multicast message. In such case, the information about stored message may be represented by at least one of a list of message identifiers, a list of range specifiers of message identifiers and a bitmap of message identifiers. The message identifier is added to each multicast message. The message identifier may be structured by a content ID and a block number. In such case, as the content ID and the block number, the seed-id field and a sequence field in the MPL Option described in Reference 2 are used.

the second transmitting and receiving unit 104 may treat all of the blocks are not received with respect to a certain adjacent node that has not sent the request for sending multicast message. Furthermore, when using a native multicast, the second transmitting and receiving unit 104 may use a product set of information about stored message in all adjacent nodes on the same multicast link as the information about stored message on the multicast link. Here, the native multicast is multicast served by a data link layer or a network layer.

The communication node device according to each embodiment can have the third transmitting and receiving unit 205 configured to execute transmission and reception of a multicast transfer control command. The third transmitting and receiving unit 205 may instruct the second transmitting and receiving unit 104 and the first transmitting and receiving unit 101 to interrupt transmission and reception of a multicast message when receiving a multicast transfer control command indicating interruption, instruct the second transmitting and receiving unit 104 and the first transmitting and receiving unit 101 to restart transmission and reception of a multicast message when receiving a multicast transfer control command indicating restart, and instruct the storage unit 102 to delete the multicast message stored in the storage unit 102 when receiving a multicast transfer control command indicating reset. In such case, the first transmitting and receiving unit 101 executes interruption or restart of transmission and reception of multicast message based on the instruction of interruption or restart from the third transmitting and receiving unit 205. The storage unit 102 may delete all the multicast messages stored in itself based on the instruction of reset from the third transmitting and receiving unit 205.

The multicast transfer control command indicating reset may include a range specifier of a multicast identifier of a scheduled multicast message (a range specifier of scheduled multicast message). In such case, when a multicast message which is not included in the range specifier of scheduled multicast message is received, the first transmitting and receiving unit 101 can directly discard the multicast message based on the instruction of reset form the third transmitting and receiving unit 205. Furthermore, the multicast transfer control command indicating interruption can include a restart time. In such case, the first transmitting and receiving unit 101 can instruct the second transmitting and receiving unit 104 and the first transmitting and receiving unit 101 to restart transmission and reception of multicast message based on the instruction of interruption from the third transmitting and receiving unit 205.

When the second transmitting and receiving unit 104 instructs the first transmitting and receiving unit 101 to transmit multicast messages stored in the storage unit 102, the second transmitting and receiving unit 104 can instruct to transmit the multicast messages in no particular order.

Furthermore, for transmitting and receiving a multicast message stored in the storage unit 102, the first transmitting and receiving unit 101 can use one of multicast and unicast. When multicast is used, it is possible to use native multicast, application layer multicast stipulated by automatic multicast tunneling or REsource LOcation And Discovery (RELOAD), or a combination thereof. As multicast on network layer, it is possible to use Trickle multicast described in Reference 1. When unicast is used, a destination node can be changed for each message. In such case, a message to be delivered is selected based on a condition of a link between adjacent nodes. For example, when a link with unstable reliability becomes available, a multicast message may be preferentially transferred to an adjacent node connected to that link.

As described above, in the above-described embodiments, by storing a transmitted or received message during a certain period, transmitting a request for sending multicast message to an adjacent node when interruption of reception continuity of multicast message from the adjacent node is detected, and transmitting a stored multicast message to an adjacent node when a request for sending multicast message is received from the adjacent node, it is possible to prevent a multicast message from being lost due to a change of a multicast routing topology, an alertness level of node, or the like, while suppressing network load and multicast transfer delay.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication node device which is capable of transmitting and receiving a multicast message with an adjacent node connected to the same multicast link, the device comprising:
a first transmitting and receiving unit configured to transmit and receive a multicast message with the adjacent node;
a storage unit configured to store a message transmitted or received by the first transmitting and receiving unit;
a detection unit configured to detect interruption of reception continuity of multicast message with the adjacent node; and
a second transmitting and receiving unit configured to, when the detection unit detects interruption of reception continuity of multicast message with the adjacent node, transmit a request for sending multicast message to the adjacent node.

2. The device according to claim 1, wherein
the second transmitting and receiving unit, when a request for sending multicast message is received from the adjacent node, instructs the first transmitting and receiving unit to send the multicast message stored in the storage unit to the adjacent node.

3. The device according to claim 1, wherein
the detection unit, when a new adjacent node is added to the multicast link, determines that reception continuity of multicast message with the new adjacent node is interrupted.

4. The device according to claim 1, wherein
the second transmitting and receiving unit uses a request for joining a multicast group as the request for sending multicast message.

5. The device according to claim 4, wherein
the second transmitting and receiving unit uses a multicast routing protocol message or a message for joining a multicast group in a multicast listener management protocol as the request for joining the multicast group.

6. The device according to claim 4, wherein
the second transmitting and receiving unit uses a DAO message of the RPL as the request for joining the multicast group.

7. The device according to claim 1, wherein
the detection unit, when an own node transits from a sleep state to an awake state, determines that reception continuities of multicast messages from all adjacent nodes on the multicast link are interrupted.

8. The device according to claim 7, wherein
the request for sending multicast message includes information about a dormant period of the own node.

9. The device according to claim 8, wherein
the first transmitting and receiving unit selectively sends a message received during the dormant period of the own node.

10. The device according to claim 1, wherein
the detection unit, when metric about reliability of a link layer for the adjacent node falls below a specific threshold, determines that reception continuity of multicast message from the adjacent nodes is interrupted.

11. The device according to claim 10, wherein
the metric about reliability of the link layer is the link quality level (LQL) or the expected transmission count metric (ETX).

12. The device according to claim 2, wherein
the request for sending multicast message includes information about stored message including a message identifier of a multicast message stored by the adjacent node, and
the second transmitting and receiving unit instructs the first transmitting and receiving unit to selectively send a multicast message not included in the information about stored message among the multicast messages stored in the storage unit.

13. The device according to claim 12, wherein
the information about stored message includes a list of range specifiers of message indentifiers.

14. The device according to claim 12, wherein
the message identifier includes a content ID and a block number.

15. The device according to claim 14, wherein
the content ID is a seed-id field in the RPL MPL option,
the block number is a sequence field in the RPL MPL option.

16. The device according to claim 12, wherein
the second transmitting and receiving unit determines that all of the blocks are not received with respect to a certain adjacent node that has not sent the information about stored message among all adjacent nodes on the multicast link.

17. The device according to claim 12, wherein
the second transmitting and receiving unit, when using a native multicast, uses a product set of information about stored message in all adjacent nodes on the multicast link as the information about stored message on the multicast link.

18. The device according to claim 1, further comprising a third transmitting and receiving unit configured to transmit and receive a multicast transfer control command, instruct the second transmitting and receiving unit and the first transmitting and receiving unit to interrupt transmission and reception of a multicast message when receiving a multicast transfer control command indicating interruption, instruct the second transmitting and receiving unit and the first transmitting and receiving unit to restart transmission and reception of a multicast message when receiving a multicast transfer control command indicating restart, and instruct the storage unit to delete the multicast message stored in the storage unit when receiving a multicast transfer control command indicating reset, wherein
the first transmitting and receiving unit interrupts or restarts transmission and reception of a multicast message based on the instruction of interruption or restart from the third transmitting and receiving unit, and
the storage unit deletes the multicast message stored therein based on the instruction of reset from the third transmitting and receiving unit.

19. The device according to claim 18, wherein
the instruction of reset includes a range specifier of a message identifier of a multicast message which is scheduled to be sent, and
the first transmitting and receiving unit discard a multicast message corresponding to a message identifier which is not included in the range specifier based on the instruction of reset from the third transmitting and receiving unit.

20. A communication system for transmitting and receiving a multicast message between a plurality of communication node devices connected to the same multicast link, wherein
each communication node device including:
a first transmitting and receiving unit configured to transmit and receive a multicast message with the other communication node device connected to the multicast link;
a storage unit configured to store a message transmitted or received by the first transmitting and receiving unit;
a detection unit configured to detect interruption of reception continuity of multicast message with the other communication node device;
a second transmitting and receiving unit configured to, when the detection unit detects interruption of reception continuity of multicast message with the other communication node device, transmit a request for sending multicast message to the other communication node device.

21. A communication control method executed by a communication node device which transmits and receives a multicast message with an adjacent node connected to the same multicast link, the method including:
storing a message transmitted to or received from the adjacent node;
detecting interruption of reception continuity of multicast message with the adjacent node; and
when interruption of reception continuity of multicast message from the adjacent node is detected, transmitting a request for sending multicast message to the adjacent node.

22. A non-transitory computer-readable program product storing instructions for operating a computer processor of a communication node device which is capable of transmitting and receiving a multicast message with an adjacent node connected to the same multicast link, the instructions including:
transmitting and receiving a multicast message with the adjacent node;
storing a message transmitted to or received from the adjacent node;
detecting interruption of reception continuity of multicast message with the adjacent node; and
when interruption of reception continuity of multicast message from the adjacent node is detected, transmitting a request for sending multicast message to the adjacent node.
